(19) United States
(12) Patent Application Publication
(10) Pub. No.: US 2010/0013846 A1
(43) Pub. Date: Jan. 21, 2010

(54) DISPLAY APPARATUS, AND IMAGE QUALITY CONVERTING METHOD AND DATA CREATING METHOD USING THE SAME

(75) Inventors: Jin-wook CHOI, Suwon-si (KR); Joung-hum Baek, Hwaseong-si (KR); Cheon-yong Cho, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/361,210

(22) Filed: Jan. 28, 2009

(30) Foreign Application Priority Data
Jul. 15, 2008 (KR) 2008-0068698

(51) Int. Cl. G09G 5/02; G09G 5/00

(52) U.S. Cl. 345/589; 345/581

(57) ABSTRACT

Display apparatus, image quality converting method and data creating method using the same are disclosed. The display apparatus includes a storage unit which stores conversion information of parameter values, a measuring unit which measures parameter values, and a control unit which controls an image quality of the received image to be converted. Even if a connector for implementing a user's desired image is not connected, the present invention can thereby reproduce the image quality of the received image as if the received image is connected using such a connector.

### CROSS-REFERENCE TO RELATED APPLICATIONS

This application claims priority from Korean Patent Application No. 10-2008-0068698, filed on Jul. 15, 2008, in the Korean Intellectual Property Office, the disclosure of which is incorporated herein by reference in its entirety.

### BACKGROUND

1. Field of the Invention

Apparatuses and methods consistent with the present invention relate to providing a display apparatus, and an image quality converting method and a data creating method using the same, and more particularly, to providing an image providing apparatus, an image outputting apparatus and an image transmitting system using conversion information of parameter values, and an image transmitting method using the same.

2. Description of the Related Art

A display apparatus such as a monitor receives and outputs images transmitted from an image providing apparatus such as a PC. In order to receive images from an image providing apparatus, the images are received using a connector such as a composite connector, a Separated-Video (S-Video) connector, a component connector, or a High-Definition Multimedia Interface (HDMI) connector, and the image quality of the images received using each type of connector is different.

As described above, various connectors are present in the image providing apparatus and the display apparatus, so a user can view images of varying image quality according to the sort of content by converting the connection state of the connectors.

However, since the image providing apparatus and display apparatus are generally connected by one cable, that is, using one sort of connector, the cable must be replaced in order to receive images using another connector, thereby causing inconvenience to a user. When the image providing apparatus and display apparatus include only one connector, a problem arises in that a separate connector must be mounted in order to convert an image.

### SUMMARY

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image providing apparatus, an image outputting apparatus and an image transmitting system using conversion information of parameter values, and an image transmitting method using the same.

According to an aspect of the present invention, there is provided a display apparatus comprising a plurality of interfaces, a storage unit which stores conversion information on parameter values according to the interface conversion, a measuring unit which measures parameter values of an image received using any one of the plurality of interfaces, and a control unit which controls the image quality of the received image to be converted using the measured parameter values and conversion information.

When a command which converts the image quality of an image received using a first interface into the image quality of a second interface is input, the control unit may control the image quality of the received image using the conversion information on the parameter values according to the conversion from the first interface to the second interface.

The image quality of the second interface may be the image quality of an image received using the first interface when the image is received using the second interface.

The conversion information may receive reference images using each of the plurality of interfaces, respectively, measure parameter values of the reference images for each interface, and match the conversion of the parameter values with the conversion of the interfaces.

The storage unit may store the conversion information in a lookup table.

The plurality of interfaces may include at least two of a high definition multimedia interface (HDMI) connector, a digital video interactive (DVI) connector, a D-sub connector, a component connector, a separated-video (S-Video) connector, and a composite connector.

The parameter values may include at least one of the red, green and blue (RGB) values, sharpness values, coring values, brightness values, and contrast values.

According to another aspect of the present invention, there is provided a display apparatus which creates data using a reference image in order to convert the image quality of a received image, the display apparatus comprising a plurality of interfaces each receiving the reference image, a measuring unit which measures parameter values of the received reference images for each interface, and a control unit which creates data matching the respective interfaces with the parameter values of the reference images received using the respective interfaces.

When a command to convert the image quality of an image received using a first interface into the image quality of a second interface is input, the control unit may convert the image quality by measuring parameter values of the image received using the first interface and using the measured parameter values and data of the first and second interfaces.

The first interface may be an interface among the plurality of interfaces where an image is received, and the second interface is an interface among the plurality of interfaces, where an image is not received.

According to another aspect of the present invention, there is provided an image quality converting method comprising storing conversion information on parameter values according to the interface conversion, measuring parameter values of an image received using any one of a plurality of interfaces, and converting the image quality of the image received using the measured parameter values and the prestored conversion information.

The image quality converting method may further comprise receiving a command which converts the image quality of an image received using a first interface into the image quality of a second interface, wherein the converting the image quality of the received image comprises converting the image quality of the received image using the conversion information on the parameter values according to the conversion from the first interface to the second interface.

The image quality of the second interface may be the image quality of an image received using the first interface when the image is received using the second interface.

The conversion information may be information that parameter values are converted according to the conversion of the interfaces, and the storing conversion information on parameter values comprises receiving reference images using the plurality of interfaces, respectively, measuring parameter values of the reference images received using the respective interfaces, and storing the conversion information.

The storing conversion information on parameter values may comprise storing the conversion information in a lookup table.

The plurality of interfaces may include at least two of a high definition multimedia interface (HDMI) connector, a digital video interactive (DVI) connector, a D-sub connector, a component connector, a separated-video (S-Video) connector, and a composite connector.

The parameter values may include at least one of the red, green and blue (RGB) values, sharpness values, coring values, brightness values, and contrast values.

According to another aspect of the present invention, there is provided a data creating method for converting image quality, the data creating method comprising receiving reference images using a plurality of interfaces, respectively, measuring parameter values of the reference images for each interface, and creating data matching the respective interfaces with the parameter values of the reference images received using the respective interfaces.

The data creating method may further comprise, when a command which converts the image quality of an image received using a first interface into the image quality of a second interface is input, converting the image quality by measuring parameter values of the image received using a first interface and using the measured parameter values and data of the first and second interfaces.

The first interface may be an interface among the plurality of interfaces where an image is received, and the second interface may be an interface among the plurality of interfaces where an image is not received.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view showing a display system according to an exemplary embodiment of the present invention;

FIG. 2 is a block diagram showing a display apparatus according to an exemplary embodiment of the present invention;

FIGS. 3A and 3B are views showing a reference image input into a measuring unit and parameters measured by the measuring unit;

FIGS. 4A and 4B are views showing data and conversion information that can be used in a display apparatus;

FIG. 5 is a view showing a lookup table stored in a storage unit; and

FIG. 6 is a flowchart showing an image quality converting method according to an exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as the detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

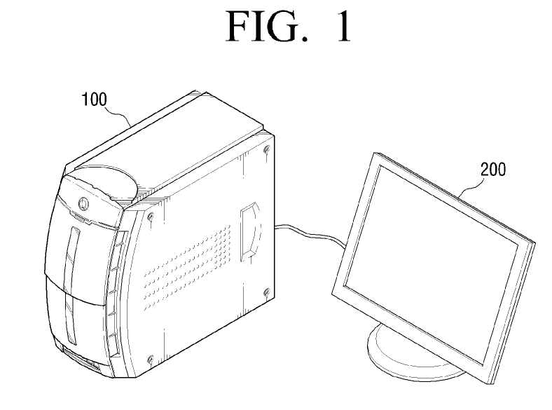

FIG. 1 is a view showing a display system according to an exemplary embodiment of the present invention. The display system according to the exemplary embodiment of the present invention is accomplished by connecting a personal computer (PC) 100 to a display apparatus 200, the PC being one kind of host apparatus.

The PC 100 and display apparatus 200 each include a plurality of connectors, and are connected to each other using any one of the plurality of connectors.

The PC 100 transmits a stored image or an image received from the outside using any one of the plurality of connectors, and the display apparatus 200 outputs the image transmitted by the PC 100.

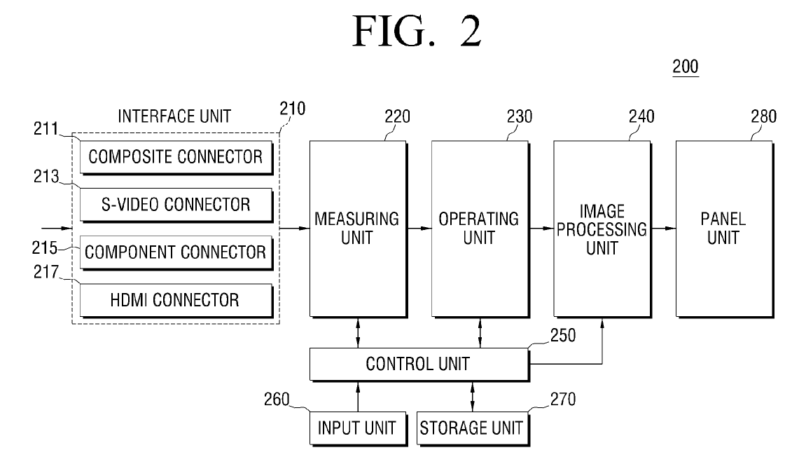

FIG. 2 is a block diagram showing a display apparatus according to an exemplary embodiment of the present invention. The display apparatus 200 includes an interface unit 210, a measuring unit 220, an operating unit 230, an image processing unit 240, a control unit 250, an inputting unit 260, a storage unit 270, and a panel unit 280.

The interface unit 210 connects the PC 100 to the display apparatus 200 using a cable and includes a plurality of connectors. More specifically, the interface unit 210 includes a composite connector 211, a Separated-Video (S-Video) connector 213, a component connector 215, and a High Definition Multimedia Interface (HDMI) connector 217.

The composite connector 211 is used for receiving a composite signal from the PC 100. The composite signal is in a from in which three source signals Y, U and V are combined with a sync pulse for synchronization. Here, Y is a source signal representing brightness information of the image, and U and V are source signals representing color information.

The S-Video connector 215 is used for receiving an S-Video signal from the PC 100. In the S-Video signal, brightness information and color information are separate. The S-Video signal may be referred to as a Y/C signal, wherein Y represents brightness information and C represents color difference information of the screen. The S-Video signal has excellent image quality compared to the composite signal, since the PC 100 transmitting an image, records and transmits the brightness information and the color difference information separately.

The component connector 217 is used for receiving a component signal from the PC 100. The component signal further subdivides the S-Video signal which separates the brightness information from the color difference information. In other words, the component signal includes brightness information of the screen, color difference information for red, and color difference information for blue. Therefore, the component signal may be represented as Y, R-Y, and B-Y, wherein R-Y and B-Y represent difference signals between two colors required in reconfiguring red, green blue signals in order to implement a color display.

The HDMI connector 217 is used for receiving an HDMI signal from the PC 100. High Definition Multimedia Interface (HDMI) is an uncompressed digital image/audio interface standard, and has the property that no separate decoder is required, since an uncompressed image is transmitted. The HDMI also has the property that complicated wires of an AV device can be simplified, since image, audio and control signals are transmitted through a single cable.

The plurality of connectors are arranged as the HDMI connector 217, component connector 215, S-Video connector 213, and composite connector 211 in the order that an excellent image quality may be provided.

The display device 200 transfers the image received by the PC 100 to the measuring unit 220 using any one of the composite connector 211, S-Video connector 213, component connector 215, and HDMI connector 217.

The measuring unit 220 measures parameters of the image received through the interface unit 210. In detail, the measuring unit 220 receives a reference image from the PC 100 using the respective connectors, and measures the parameters of the received reference image for each connector. The measuring unit 220 also receives a source image using a connector which connects the PC 100 to the display apparatus 200, and measures the parameters of the received source image.

Here, the reference image refers to an image for creating conversion information that reflects the conversion of parameter values according to the conversion of the connector, and the source image refers to an image that a user actually desires to view, and that is emulated using the created conversion information.

The reference image refers to an image that aims to create the conversion information, which is used for the emulation of the source image, and the source image is an image for emulation, that a user actually views.

The parameters refer to measuring standards for image quality, such as the red, green and blue (RGB) values, the sharpness, the coring, the brightness, and the like.

The measuring unit 220 receives the reference image and measures the parameters of the reference image.

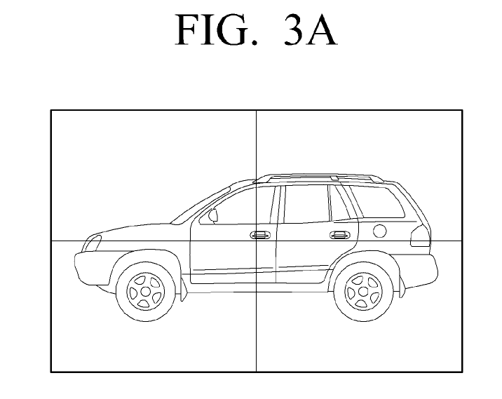

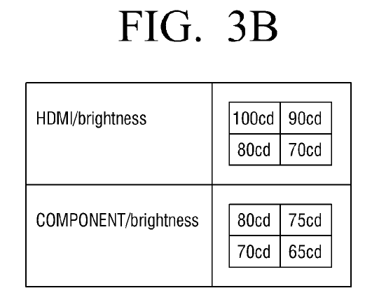

Hereinafter, the operation of the measuring unit 220 will be described with reference to FIGS. 3A and 3B. FIG. 3A is a view showing a reference image input into the measuring unit 220, and FIG. 3B is a view showing parameters measured by the measuring unit 220.

As shown in FIG. 3A, if the reference image is input, the measuring unit 220 divides the received reference image into four sections, and measures a plurality of parameters for connectors for each section. That is, as shown in FIG. 3A, if the reference image is divided into four sections, there are four connectors connecting a PC 100 to a display apparatus 200, and parameters to be measured are brightness and sharpness, the measuring unit 220 measures the brightness a total of sixteen times (4*4) and the sharpness a total of sixteen times (4*4) for the reference image.

In FIG. 3B, the measured values of the parameters using the reference image are shown by limiting parameters to brightness and the connectors to a component connector 215 and a HDMI connector 217.

Referring to FIG. 3B, for the reference image received using the component connector 215, it can be seen that the brightness of the upper left of the image is 80 candela (cd), the brightness of the upper right is 75 cd, the brightness of the lower left is 70 cd, and the brightness of lower right is 65 cd.

For the reference image received using the HDMI connector 217, it can be seen that the brightness of the upper left is 100 cd, the brightness of the upper right is 90 cd, the brightness of the lower left is 80 cd, and the brightness of the lower right is 70 cd.

Referring to FIG. 2 again, the measuring unit 220 transmits the measured values of parameters to an operating unit 230.

The measuring unit 220 may also be used for receiving a source image and measuring the parameters of the source image. The measuring unit 220 receives the source image, measures the parameters of the source image in the same manner as the reference image, and transmits the measured values of parameters to the operating unit 230.

As described above, the parameters are measured by dividing the received reference image and source image into four sections. However, this is nothing but an example for simplifying the description. The technical idea of the present invention may also be applied to the case in which the parameters are not measured by dividing the received reference image and source image, or the case in which the received reference image is divided into a number of sections other than four.

The present invention may also be applied to the case that the parameters are each measured using a different method, e.g., dividing the reference image into four sections and not dividing the source image.

The operating unit 230 converts the parameter values measured by the measuring unit 220 into processed data that can be used in a display apparatus. The parameter values measured by the measuring unit 220 have a unit corresponding to each parameter.

The parameter values measured by the measuring unit 220 are converted into unified data values that can be used in the display apparatus 200. The operating unit 230 thus processes and converts the parameter values measured by the measuring unit 220 into data values that can be used in the display apparatus 200.

In other words, the operating unit 230 processes and converts the parameter values of the reference image and source image measured by the measuring unit 220 into data values that can be used in the display apparatus.

When the parameter values of the reference image are received from the measuring unit 220, the operating unit 230 creates conversion information that data corresponding to the parameter values measured by the measuring unit 220 are converted according to the conversion of the connectors. The created conversion information is stored in a storage unit 270 to be described later.

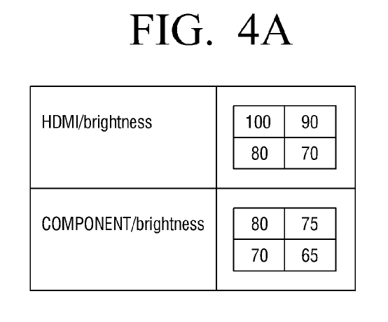

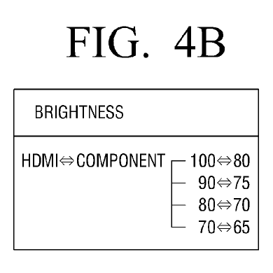

Hereinafter, the operation of the operating unit 230 will be described with reference to FIGS. 4A and 4B. FIG. 4A is a view showing data values that can be used in a display apparatus, and FIG. 4B is a view showing conversion information.

As shown in FIG. 4A, the operating unit 230 receiving the parameter values of the reference image measured by the measuring unit 220 converts the measured parameter values into values that can be used in a display apparatus 200 according to a preset standard, since the measured parameter values have a separate unit for each parameter. Therefore, the operating unit 230 converts 65 cd into a data value of 65, 70 cd into a data value of 70, 75 cd into a data value of 75, 80 cd into a data value of 80, 90 cd into a data value of 90, and 100 cd into a data value of 100.

The operating unit 230 receives the parameter values of the source image from the measuring unit 220 and converts the received parameter values into data values that can be used in the display apparatus 200, in the same manner as the case in which the reference image is received.

The process to convert the brightness is described as an example of the parameter values. However, parameters other than the brightness may also be converted in the same manner. The process to convert the brightness described above is described based on the component connector 215 and HDMI connector 217. However, the brightness may also be converted using other connectors, such as the composite connector 212 and S-Video connector 213, in the same manner.

Data conversion using the numbers is provided as an example for convenience. However, the technical idea of the present invention may also be applied to the case in which data are converted using characters or symbols, instead of numbers.

FIG. 4B is a view showing conversion information. The operating unit 220 creates conversion information matching each data value with connectors using the converted data values. For example, FIG. 4B shows conversion information which matches the parameter values of the image received using the component connector 215 and HDMI connector 217 with data values which are converted so as to be used in the display apparatus 200. In other words, the conversion data is information matching the changed connectors with data values that can be used in the display apparatus 200.

Referring to FIG. 4B, when the component connector 215 is converted into the HDMI connector 217, it is known that a data value of 65 is converted into a data value of 70, a data value of 70 into a data value of 80, a data value of 75 into a data value of 90, and a data value of 80 into a data value of 100.

Referring to FIB. 4B, when the HDMI connector 217 is converted into the component connector 215, it is known that a data value of 70 is converted into a data value of 65, a data value of 80 into a data value of 70, a data value of 90 into a data value of 75, and a data value of 100 into a data value of 80.

Referring to FIG. 2 again, the conversion information created by the operating unit 230 is converted into a lookup table to be stored in the storage unit 270. In detail, the conversion information created by the operating unit 230 is converted into the lookup table by the control of the control unit 250 and stored in the storage unit 270.

The image processing unit 240 emulates the source image using the data values of the source image transferred by the operating unit 230 and the lookup table for the reference image transferred by the storage unit 270.

The input unit 260 is used for receiving a user emulation command using an operation means provided on the monitor. In other words, the user may input an emulation command, using the input unit 260, such that the image quality of the source image received using a certain connector appears to be the image quality of the source image received using another connector.

The storage unit 270 is a storage means for storing the lookup table generated by the operating unit 230 and may use various recording media, for example, a hard disk drive (HDD).

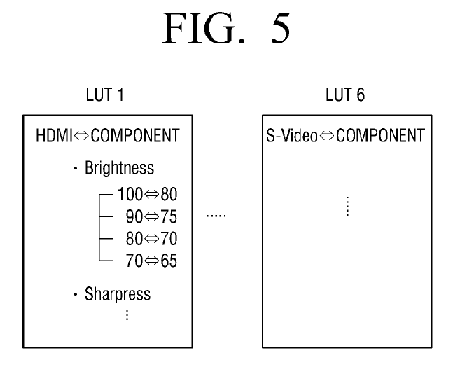

FIG. 5 is a view showing a lookup table stored in a storage unit. The display apparatus 200 is an interface and has four connectors, the interface being connectable to the PC 100. There are thus a total of six lookup tables for the conversion information that two connectors are connected to each other.

In other words, the lookup tables include a lookup table 1 on the conversion information between a component connector 215 and a HDMI connector 217, a lookup table 2 on the conversion information between an S-Video connector 213 and the HDMI connector 217, a lookup table 3 on the conversion information between a composite connector 211 and the HDMI connector 217, a lookup table 4 on the conversion information between the S-Video connector 213 and component connector 215, a look up table 5 on the conversion information between the composite connector 210 and component connector 215, and a lookup table 6 on the conversion information between the composite connector 211 and S-Video connector 213.

In the lookup table 1, the information on the conversion of data values when the component connector 215 is converted into the HDMI connector 217 and the HDMI connector 217 is converted into the component connector 215 are stored for each parameter.

When the source image is received using the HDMI connector 217, if the user inputs the emulation command for the image quality received by the component connector 215, the control unit 250 converts the parameters, such as the brightness, sharpness and the like of the source image, using the lookup table 1 generated based on the reference image.

For example, when the brightness of the source image received using the HDMI connector 217 is 80 cd, the operating unit 230 converts 80 cd into a data value of 80, and the image processing unit 240 converts the brightness of the source image using the conversion information that 80 is to be converted into 70 in the converted data values and lookup table.

When the image is received using the HDMI connector 217, it may be emulated as if the image is received using the component connector 215.

In the above, the parameter of the brightness has been provided as an example, however, the technical idea of the present invention may also be applied to the case when it is emulated as if all parameters of the source image using the HDMI connector 217 are input using the component connector 215.

The panel unit 280 displays the image emulated by the image processing unit 240 on a display apparatus such as a liquid crystal display (LCD), a plasma display panel (PDP) or the like and provides the displayed image to a user.

The control unit 250 controls a general operation of the display apparatus 200. In particular, the control unit 250 1) determines by which connector among a plurality of connectors connector the reference image or the source image is received, 2) controls the measuring unit 220 so that that the parameter values of the received reference image or source image can be extracted, and 3) controls the operating unit 230 so that the extracted parameter values are converted into data values that can be used in the display apparatus 200. The control unit 250 also 4) controls the lookup table generated by the operating unit 230 to be stored in the storage unit 270, 5) controls the image processing unit 240 so that the image quality of the image input to a certain connector can emulate the image quality of the image input to another connector according to the user emulation command input using the input unit 260, and displays the emulated image on the panel unit 280.

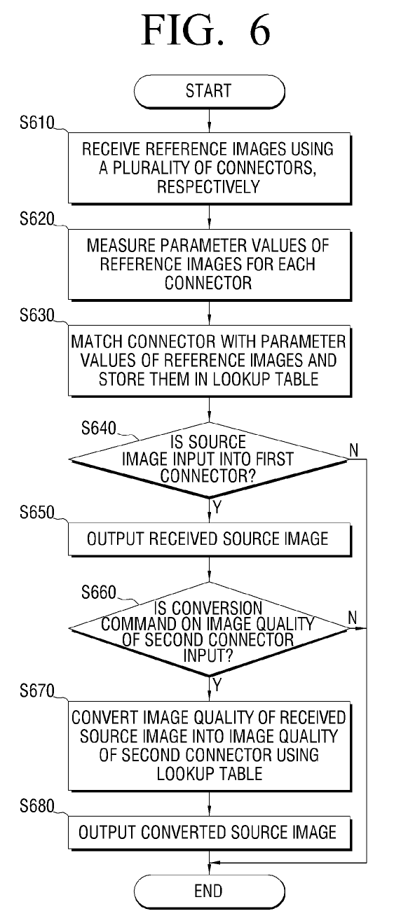

FIG. 6 is a flowchart showing an image quality converting method according to an exemplary embodiment of the present invention.

First, a display apparatus 200 receives reference images, respectively, using a plurality of connectors in operation 610. Thereafter, a measuring unit 220 measures parameters of the received reference images for each the plurality of connectors in operation S620.

The storage unit 270 matches the connectors and the parameter values of the reference image to generate a lookup table according to the control of the control unit 250 and stores the generated lookup table. In more detail, the operating unit 230 converts the parameter values measured by the measuring unit 220 into data values that can be used in the display apparatus 200 and matches the converted data values with connectors to generate the lookup table, and the storage unit 270 stores the generated lookup table in operation S630.

If the lookup table is completed using the reference image in this manner, the emulation on the source image to be input subsequently can be performed.

In more detail, if the source image is input into a first connector of a plurality of connectors in operation S640-Y, the display apparatus 200 outputs the input source image itself before there is an image conversion command in operation S650.

Thereafter, if a conversion command into the image quality of a second connector is input using a input unit 260 in operation S660-Y, the control unit 250 controls an image processing unit 240 such that the image quality of the received source image is converted into the image quality of the second connector using the lookup table stored in the storage unit 270 in operation S670. In other words, the image processing unit 240 emulates and transfers the source image to the panel unit 280 according to the control of the control unit 250. Thereafter, the panel unit 280 outputs the received image in operation S680.

The conversion information and lookup table are created by receiving the reference image and then the received source image is emulated after the conversion information and lookup table have been created. However, the present invention may also be applied to the case when the source image is emulated without creating the conversion information and lookup table using the reference image. In this case, the conversion information and lookup table created by another method should be stored in the storage unit 270.

The exemplary connectors provided in the interface unit 210 described above are the composite connector 211, S-Video connector 213, component connector 215 and HDMI connector. However, they may also include another connectors such as a DVI connector or a D-sub connector.

The parameters of the image described above include RGB, sharpness, coring and brightness. However, parameters other than the above may also be applied to the emulation.

As described above, according to an exemplary embodiment of the present invention, for an image to be received, even if a connector for implementing a user's desired image is not connected, the image quality of the received image can be reproduced as if the received image is connected using such a connector. In particular, a user can convert an image into his or her desired image quality according to the sort of content, the image quality felt by the user can thereby be improved.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus, comprising:
a plurality of interfaces;
a storage unit which stores conversion information of parameter values corresponding to an interface conversion;
a measuring unit which measures parameter values of an image received using any one of the plurality of interfaces; and
a control unit which controls the image quality of the received image to be converted using the measured parameter values and the conversion information.

2. The display apparatus as claimed in claim 1, wherein when a command to convert a first image quality of a first image received using a first interface into a second image quality corresponding to a second interface is input, the control unit controls the first image quality to be converted by using the conversion information of the parameter values corresponding to an interface conversion from the first interface to the second interface.

3. The display apparatus as claimed in claim 2, wherein the second image quality is an image quality of the first image when the first image is received using the second interface.

4. The display apparatus as claimed in claim 1, wherein the conversion information comprises information corresponding to parameter values that are converted for the interface conversion when each of the plurality of interfaces receives a reference image and the measuring unit measures parameter values of the reference image for each interface.

5. The display apparatus as claimed in claim 1, wherein the storage unit stores the conversion information in a lookup table.

6. The display apparatus as claimed in claim 1, wherein the plurality of interfaces include at least two of a high definition multimedia interface (HDMI) connector, a digital video interactive (DVI) connector, a D-sub connector, a component connector, a separated-video (S-Video) connector, and a composite connector.

7. The display apparatus as claimed in claim 1, wherein the parameter values include at least one of the red, green and blue (RGB) values, sharpness values, coring values, brightness values, and contrast values.

8. A display apparatus which creates conversion data using a reference image in order to convert an image quality of a received image, the display apparatus comprising:
a plurality of interfaces which each receive the reference image;
a measuring unit which measures parameter values of the received reference image for each interface; and
a control unit which creates the conversion data matching each of the interfaces with the parameter values of the reference image received using each of the interfaces.

9. The display apparatus as claimed in claim 8, wherein when a command to convert a first image quality of a first image received using a first interface into a second image quality corresponding to a second interface is input, the control unit converts the first image quality by measuring parameter values of the first image and using the measured parameter values and the conversion data corresponding to the first and second interfaces.

10. The display apparatus as claimed in claim 9, wherein the first interface is an interface among the plurality of interfaces where an image is received, and the second interface is an interface among the plurality of interfaces where an image is not received.

11. An image quality converting method, comprising:
storing conversion information on parameter values corresponding to an interface conversion;
measuring parameter values of an image received using any one of a plurality of interfaces; and
converting the image quality of the image received using the measured parameter values and the stored conversion information.

12. The image quality converting method as claimed in claim 11, further comprising:
receiving a command which converts a first image quality of a first image received using a first interface into a second image quality corresponding to a second interface,
wherein the converting the first image quality comprises converting the first image quality using the conversion information of the parameter values corresponding to the conversion from the first interface to the second interface.

13. The image quality converting method as claimed in claim 12, wherein the second image quality is an image quality of the first image when the first image is received using the second interface.

14. The image quality converting method as claimed in claim 11, wherein the conversion information comprises information corresponding to which parameter values are converted for the interface conversion, and the storing conversion information on parameter values further comprises:
receiving a reference image using each of the plurality of interfaces; and
measuring parameter values of the reference images received using each of the plurality of interfaces.

15. The image quality converting method as claimed in claim 11, wherein the storing conversion information on parameter values comprises storing the conversion information in a lookup table.

16. The image quality converting method as claimed in claim 11, wherein the plurality of interfaces include at least two of a high definition multimedia interface (HDMI) connector, a digital video interactive (DVI) connector, a D-sub connector, a component connector, a separated-video (S-Video) connector, and a composite connector.

17. The image quality converting method as claimed in claim 11, wherein the parameter values include at least one of the red, green and blue (RGB) values, sharpness values, coring values, brightness values, and contrast values.

18. A conversion data creating method for converting image quality, the conversion data creating method comprising:
receiving a reference image using each of a plurality of interfaces;
measuring parameter values of the reference image for each interface; and
creating conversion data matching each of the interfaces with the parameter values of the reference image received using each of the interfaces.

19. The conversion data creating method as claimed in claim 18, further comprising:
when a command to convert a first image quality of a first image received using a first interface into a second image quality corresponding to a second interface is input, converting the first image quality by measuring parameter values of the image received using the first interface and using the measured parameter values and the conversion data of the first and second interfaces.

20. The data creating method as claimed in claim 19, wherein the first interface is an interface among the plurality of interfaces where an image is received, and the second interface is an interface among the plurality of interfaces where an image is not received.
